(19) United States
(12) Patent Application Publication
(10) Pub. No.: US 2007/0033523 A1
(43) Pub. Date: Feb. 8, 2007

(54) Method, apparatus, and system for delivering information with improved user operability

(76) Inventor: Hisashi Tanaka, Kanagawa-Ken (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/492,104

(22) Filed: Jul. 25, 2006

(30) Foreign Application Priority Data
Jul. 25, 2005 (JP) 2005-214488

(51) Int. Cl. G06F 17/30; H04L 9/00

(52) U.S. Cl. 715/526; 713/182

(57) ABSTRACT

An information delivery system includes an input apparatus configured to acquire predetermined information, and an information delivery apparatus connected to the input apparatus, and configured to perform an information delivery operation in cooperation with the input apparatus, to acquire specific information of the input apparatus, and to restrict setting for execution of the information delivery operation according to the specific information of the input apparatus. An information delivery method includes acquiring specific information of an input apparatus by using an information delivery apparatus, restricting setting for execution of an information delivery operation by using the information delivery apparatus according to the specific information of the input apparatus, acquiring predetermined information by using the input apparatus, acquiring the predetermined information from the input apparatus by using the information delivery apparatus, and delivering the acquired information to a predetermined destination by using the information delivery apparatus.

### CROSS REFERENCE TO RELATED APPLICATION

This application is based upon and claims the benefit of priority from the prior Japanese Patent Application No. 2005-214488 filed on Jul. 25, 2005, the entire contents of which are incorporated herein by reference.

### BACKGROUND OF THE INVENTION

1. Field of the Invention

The present invention relates to a system and a method for information delivery, and an information delivery apparatus for use in the information delivery system, and more particularly to a system and a method for information delivery with improved user operability by restricting settings used for execution of information delivery, and an information delivery apparatus for use in the information delivery system.

2. Discussion of the Background

The background information delivery system is represented, for example, by a document delivery system used for delivering document data input from an input apparatus such as a digital multifunction printer (MFP) to a user operated computer through a document delivery apparatus which serves as a server on a network.

For example, the background information delivery system generates a profile by using an operation history of an information apparatus used by a user so as to attempt to perform information delivery without imposing a strain on the user.

The background information delivery system includes a plurality of input apparatuses, a document delivery apparatus, and a storage apparatus.

A user selects one of the plurality of input apparatuses to link with the document delivery apparatus for information delivery by using an MFP management function of the document delivery apparatus. The document delivery apparatus acquires from the input apparatus information on functions included in the input apparatus. The user then selects one of the functions on the selected input apparatus (e.g. a scanned-information delivery function and a facsimile delivery function). Then, the document delivery apparatus sends setting information including information indicating the selected function to the input apparatus. The document delivery apparatus also sends at least one forward destination of information delivery to the input apparatus.

The input apparatus receives the setting information from the document delivery apparatus, and recognizes the selected function. When a user starts a predetermined operation for executing the function, the input apparatus displays the forward destination received from the document delivery apparatus on a display unit such as an operation panel. The user determines the forward destination and detailed setting of the function such as resolution, gradation from binary to a multi level, and paper size.

For example, when a user places a paper document on a scanner unit of the input apparatus, and selects a scanner function, the input apparatus displays a forward destination list on the operation panel. The user selects a desired forward destination, and starts a scan operation. The input apparatus performs the scan operation, and sends scanned document data and the selected forward destination to the document delivery apparatus. The document delivery apparatus receives the document data and the forward destination. The document delivery apparatus delivers the document data to the forward destination according to a delivery method previously set in an apparatus of destination.

### SUMMARY OF THE INVENTION

This patent specification describes, as one example, an information delivery system including an input apparatus configured to acquire predetermined information, and an information delivery apparatus connected to the input apparatus, and configured to perform an information delivery operation in cooperation with the input apparatus, to acquire specific information of the input apparatus, and to restrict settings used to execute the information delivery operation according to the specific information of the input apparatus.

This patent specification further describes, as one example, an information delivery apparatus used in an information delivery system, including an information delivery mechanism configured to deliver information acquired by an input apparatus to a predetermined destination, a specific information acquisition mechanism configured to acquire specific information of the input apparatus, and a restriction mechanism configured to restrict settings used to execute an information delivery operation according to the specific information of the input apparatus.

This patent specification further describes, as one example, an information delivery method including acquiring specific information of an input apparatus by using an information delivery apparatus, restricting setting for execution of an information delivery operation by using the information delivery apparatus according to the specific information of the input apparatus, acquiring predetermined information by using the input apparatus, acquiring the predetermined information from the input apparatus by using the information delivery apparatus, and delivering the acquired information to a predetermined destination by using the information delivery apparatus.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating an exemplary configuration of an information delivery system according to an exemplary embodiment of the present invention;

FIG. 2 is a flowchart of an exemplary operation performed on a document delivery system included in the information delivery system shown in FIG. 1;

FIG. 3 is a flowchart of exemplary operations performed on an MFP and the document delivery system included in the information delivery system shown in FIG. 1;

FIG. 4 is a block diagram illustrating an exemplary configuration of an information delivery system according to another exemplary embodiment of the present invention;

FIG. 5 is a flowchart of an exemplary operation performed on a document delivery system included in the information delivery system shown in FIG. 4; and

FIG. 6 is a flowchart of exemplary operations performed on an MFP and the document delivery system included in the information delivery system shown in FIG. 4.

### DETAILED DESCRIPTION OF PREFERRED EMBODIMENTS

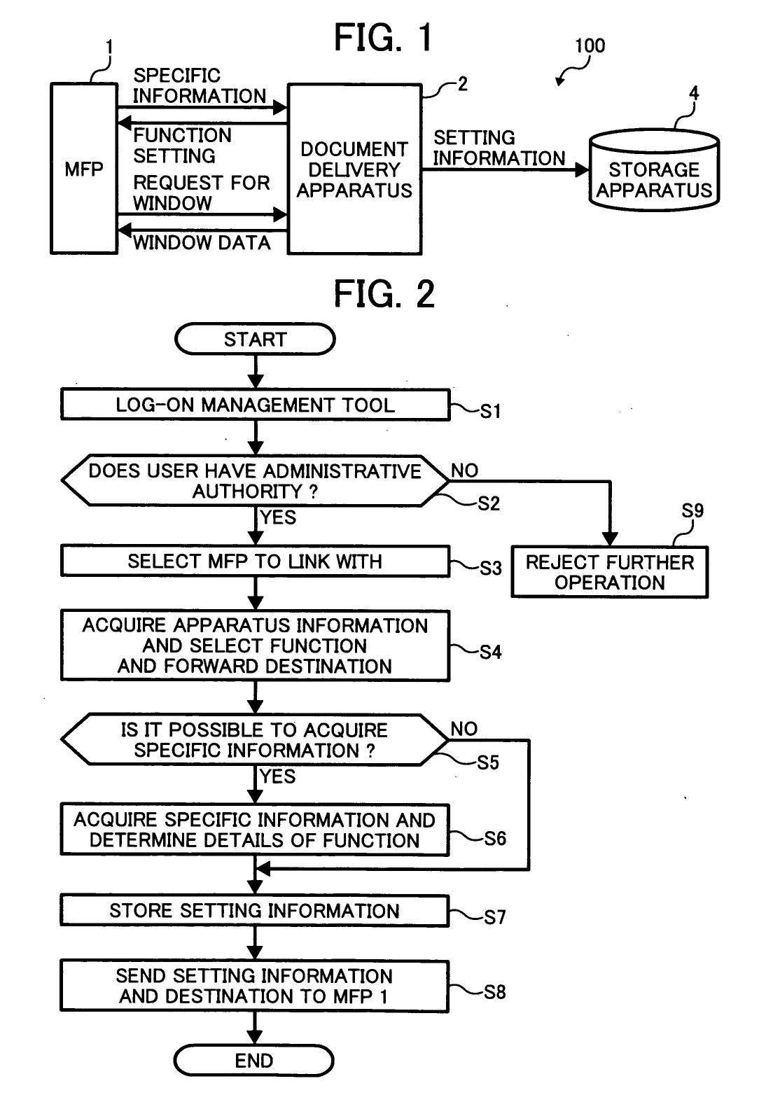

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a document delivery system according to an exemplary embodiment of the present invention is described.

A configuration of a document delivery system 100 which serves as an information delivery system is described below referring to FIG. 1. Components of the document delivery system 100 include a multifunction printer (hereinafter referred to as MFP) 1 which serves as an input apparatus, a document delivery apparatus 2, an information apparatus (not shown) such as an information processing apparatus, and a storage apparatus 4. The components of the document delivery system 100 are connected to each other via a network.

The MFP 1 includes a function for acquiring data of, for example, a paper document, a function for performing a communication operation by linking with the document delivery apparatus 2, an operation input unit, and an operation panel which serves as a display unit. The MFP 1 converts acquired data of a paper document to electronic data through a scanning operation or the like, and sends the electronic document data to the document delivery apparatus 2. A digital multifunction printer, a scanner, a facsimile, a copier, a printer, and so forth may also serve as the input apparatus of the document delivery system 100. A user inputs an operation to the MFP 1 by using the operation input unit. The operation panel is provided for a document delivery operation and a user authentication operation.

The document delivery apparatus 2 is an information processing apparatus provided with a server software application. The document delivery apparatus 2 includes a management tool, an MFP management function for selecting an MFP to link with the document delivery apparatus 2 and for selecting a function to be executed on the selected MFP, and an information delivery program including a function for delivering document data sent from the MFP 1 to the information apparatus specified as a destination to which the document delivery apparatus 2 delivers the document data sent from the MFP 1. The information apparatus receives the document data delivered by the document delivery apparatus 2. Examples of the information apparatus include a personal computer used by a user, a digital multifunction printer, and so forth.

The storage apparatus 4 stores various types of information including the setting information. Examples of the storage apparatus 4 include a database.

An operation to be performed on the document delivery apparatus 2 for setting a linkage function between the MFP 1 and the document delivery apparatus 2 according to the embodiment of the present invention is described below referring to FIG. 2. Only a user having administrative authority may perform the setting operation.

In step S1, a user logs on to the management tool installed in the document delivery apparatus 2. In step S2, the management tool checks whether or not the user has administrative authority.

When the user does not have the administrative authority (No in step S2), the user is rejected and cannot perform the setting operation (step S9).

When the user has the administrative authority (Yes in step S2), the user selects the MFP 1 as an MFP to link with the document delivery apparatus 2 by using the MFP management function of the document delivery apparatus 2 (step S3). Then, in step S4, the document delivery program causes the document delivery apparatus 2 to acquire apparatus information including information on functions included in the MFP 1 (for example, a scan distribution function and a facsimile distribution function), and the user selects one of the functions to execute on the MFP 1 based on the acquired apparatus information, and at least one forward destination to which the user desires to deliver information acquired by the MFP 1. Information on a result of the selection is dealt as setting information.

In step 5, the document delivery apparatus 2 judges whether or not specific information of the MFP 1 can be acquired. The specific information includes details of the functions of the MFP 1, such as resolution, binary/multi-value, and a paper size).

When the specific information of the MFP 1 cannot be acquired (No in step S5), the document delivery apparatus 2 stores the setting information in the storage apparatus 4 (step S7). Then, in step S8, the document delivery apparatus 2 sends the setting information and the forward destination to the MFP 1 so as to inform the MFP 1 of the function to perform.

When the specific information of the MFP 1 can be acquired (Yes in step S5), the document delivery program causes the document delivery apparatus 2 to acquire the specific information from the MFP 1, and the user determines detailed settings of the selected function based on the received specific information, thereby deciding what kind of settings are available to a user of the MFP 1 (step S6). Information on a result of the decision is added to the setting information. In other words, when the MFP 1 performs the selected function, the unavailable detailed settings restrict the selected function. Then, in step S7, the document delivery apparatus 2 stores the setting information in the storage apparatus 4. Further, in step S8, the document delivery apparatus 2 sends the setting information and the at least one forward destination to the MFP 1 so as to inform the MFP 1 of the function to perform.

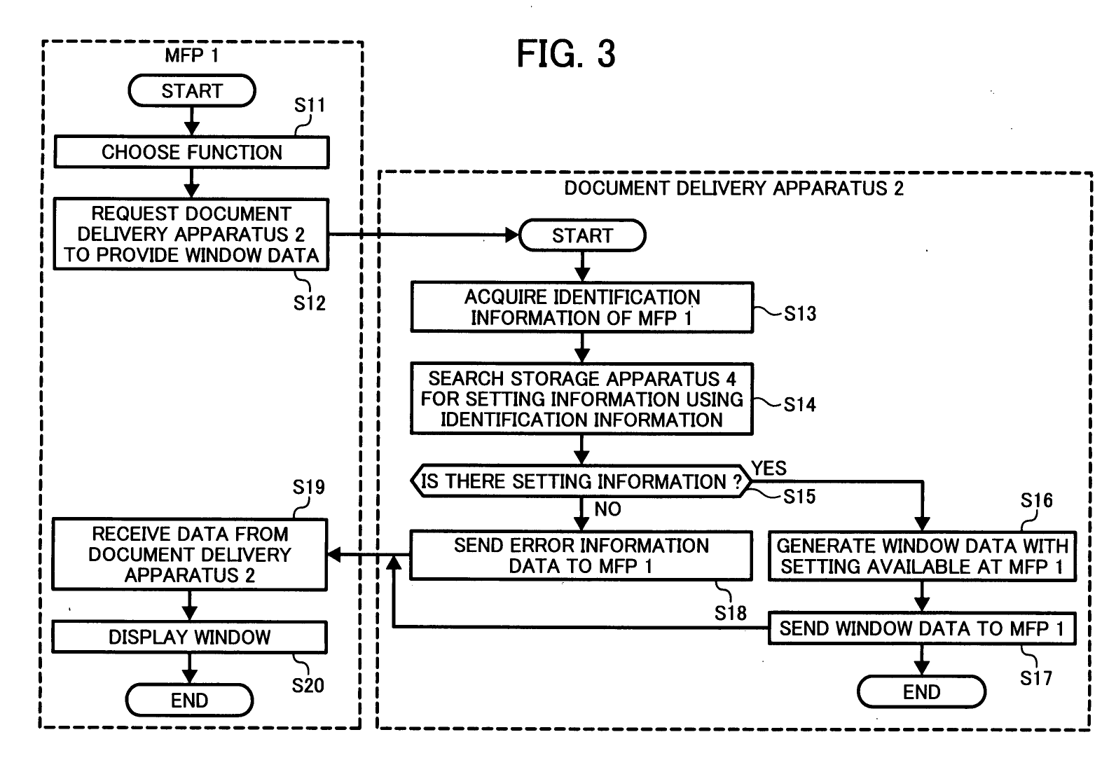

Next, operations performed on the MFP 1 and the document delivery apparatus 2 for delivering information acquired from the MFP 1 are described below referring to FIG. 3.

When a user chooses a function of the MFP 1 to be performed by linkage between the MFP 1 and the document delivery apparatus 2 (step S11), the MFP 1 requests the document delivery apparatus 2 to provide window data for the operation panel (step S12).

In step S13, the document delivery apparatus 2 acquires identification information of the requesting MFP 1. In step S14, the document delivery apparatus 2 searches the storage apparatus 4 for any setting information previously stored in association with the identification information. In step S15, the document delivery apparatus 2 judges whether or not the relevant setting information has been stored in the storage apparatus 4.

When the setting information is found (Yes in step S15), the document delivery apparatus 2 generates the requested window data for prompting the user to input a setting available at the MFP 1 (step S16). Then, in step S17, the document delivery apparatus 2 sends the generated data to the MFP 1. Further, in step S19, the MFP 1 receives the data from the document delivery apparatus 2, and, in step S20, displays a window on the operation panel according to the received data.

When the setting information is not found (No in step S15), the document delivery apparatus 2 sends data indicating an error to the MFP 1 (step S18). Then, in step S19, the MFP 1 receives the data from the document delivery apparatus 2, and, in step S20, displays a window on the operation panel according to the received data.

Step S20 is followed by the same operation as in the background information delivery system.

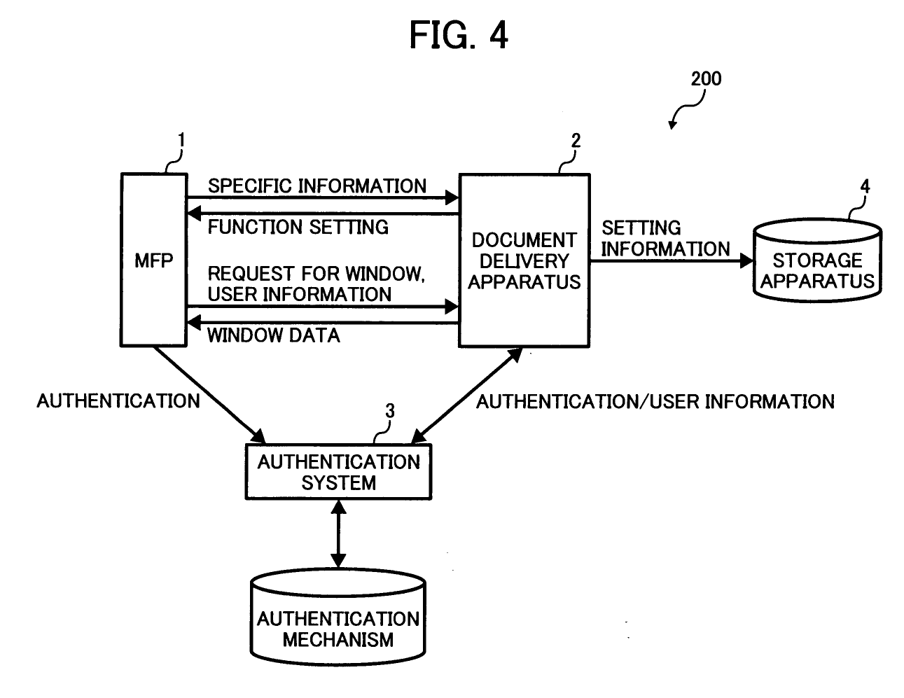

Next, another embodiment of the present invention is described below referring to FIGS. 4 to 6. As shown in FIG. 4, a document delivery system 200 includes an authentication system 3 in addition to the components of the document delivery system 100. The same reference numerals as the reference numerals used in the above description of the document delivery system 100 represent the same components, and explanation thereof is omitted.

The authentication system 3 performs authentication of a user in response to requests for authentication and acquisition of user information from the MFP 1 and the document delivery apparatus 2. The authentication system 3 is an information processing apparatus provided with a server software application.

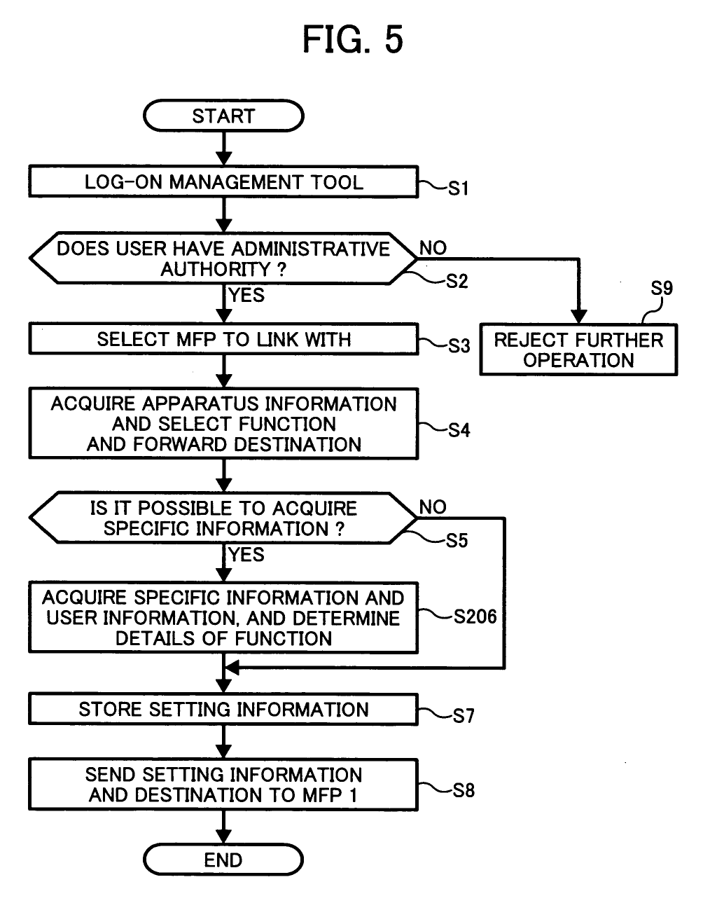

An operation for setting a linkage function between the MFP 1 and the document delivery apparatus 2 according to the embodiment of the present invention is described below referring to FIG. 5. Explanations of the same steps as the steps in the setting operation of the document delivery system 100 are omitted.

When the specific information of the MFP 1 can be acquired (Yes in step S5), the document delivery program causes the document delivery apparatus 2 to acquire the specific information from the MFP 1 and to acquire user information from the authentication system 3, and the user determines detailed settings of the selected function based on the specific information as well as the user information, thereby deciding what kind of settings are available to a user of the MFP 1 (step S206). The determined detailed settings are then added to the setting information. In other words, when the MFP 1 performs the selected function, the unavailable detailed settings restrict the selected function. Then, in step S207, the document delivery apparatus 2 stores the setting information in the storage apparatus 4.

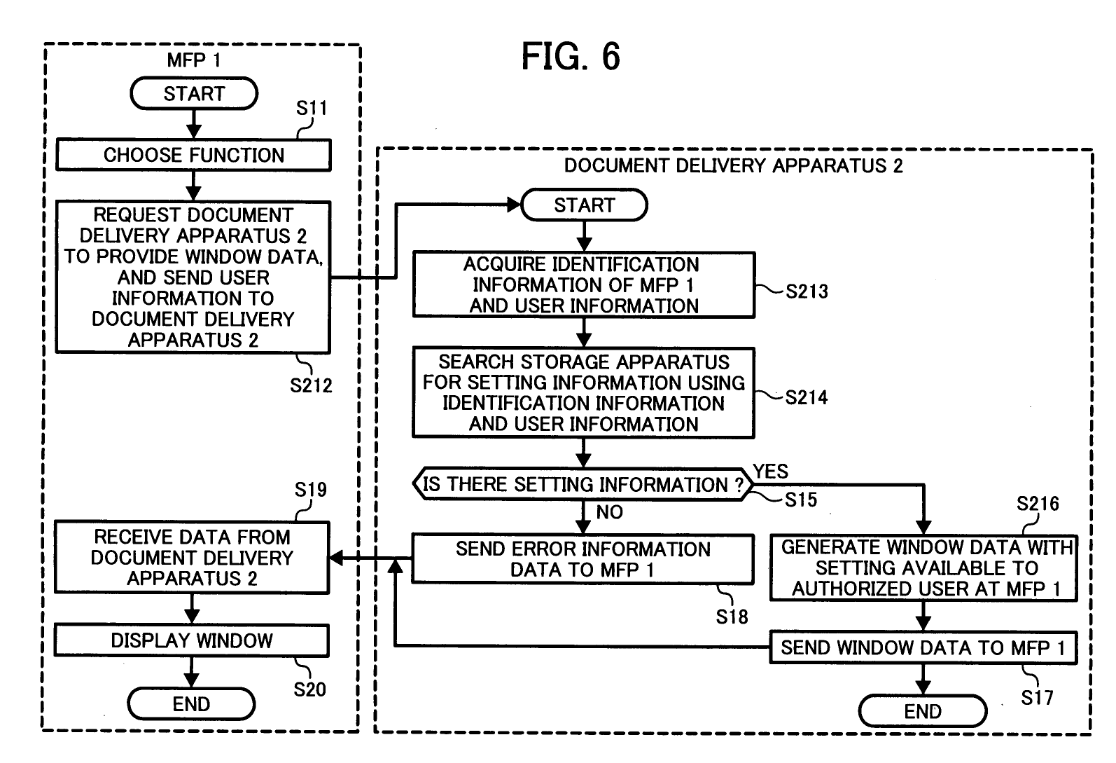

Next, operations performed on the MFP 1 and the document delivery apparatus 2 for delivering information acquired from the MFP 1 are described below referring to FIG. 6. Explanations of the same steps as the steps in the delivery operation of the document delivery system 100 are omitted.

When a user chooses a function of the MFP 1 to be performed by linkage between the MFP 1 and the document delivery apparatus 2 (step S11), the MFP 1 requests the document delivery apparatus 2 to provide window data for the operation panel, and sends information of the user to the document delivery apparatus 2 (step S212).

In step S213, the document delivery apparatus 2 acquires identification information of the requesting MFP 1 as well as the user information. In step S14, the document delivery apparatus 2 searches the storage apparatus 4 for any setting information previously stored in association with the identification information and the user information.

When the setting information is found (Yes in step S15), the document delivery apparatus 2 generates the requested window data for prompting the user to input only settings available to an authorized user at the MFP 1 (step S216).

This invention may be conveniently implemented using a conventional general purpose digital computer programmed according to the teachings of the present invention, as will be apparent to those skilled in the computer art. Appropriate software coding can readily be prepared by skilled programmers based on the teachings of the present invention, as will be apparent to those skilled in the software art. The present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this invention may be practiced otherwise than as specifically described herein.

This patent specification is based on a Japanese patent application, No. JP2005-214488 filed on Jul. 25, 2005 in the Japan Patent Office, the entire contents of which are incorporated by reference herein.

What is claimed as new and desired to be secured by Letters Patent of the United States is:

1: An information delivery system, comprising:
an input apparatus configured to acquire predetermined information; and
an information delivery apparatus connected to the input apparatus, and configured to perform an information delivery operation in cooperation with the input apparatus, to acquire specific information of the input apparatus, and to restrict settings used to execute the information delivery operation according to the specific information of the input apparatus.

2: The information delivery system according to claim 1, wherein the information delivery apparatus includes a storage mechanism for storing setting information including the settings.

3: The information delivery system according to claim 2, wherein the information delivery apparatus is configured to generate a window to be displayed on the input apparatus according to the setting information.

4: The information delivery system according to claim 3, further comprising an authentication apparatus configured to perform authentication of a user by using information on the user,
wherein the information delivery apparatus controls the settings used to execute the information delivery operation according to the specific information of the input apparatus and the information on the user.

5: An information delivery apparatus for use in an information delivery system, comprising:
an information delivery mechanism configured to deliver information acquired by an input apparatus to a predetermined destination;
a specific information acquisition mechanism configured to acquire specific information of the input apparatus; and
a restriction mechanism configured to restrict settings used to execute an information delivery operation according to the specific information of the input apparatus.

6: An information delivery method, comprising:
acquiring specific information of an input apparatus by using an information delivery apparatus;
restricting settings used to execute an information delivery operation by using the information delivery apparatus according to the specific information of the input apparatus;
acquiring predetermined information by using the input apparatus;
acquiring the predetermined information from the input apparatus by using the information delivery apparatus; and
delivering the acquired information to a predetermined destination by using the information delivery apparatus.

7: The information delivery method according to claim 6 further comprising storing setting information including the setting.

8: The information delivery method according to claim 7 further comprising generating a window to be displayed on the input apparatus by using the information delivery apparatus according to the setting information.

9: The information delivery method according to claim 8 further comprising controlling settings used to execute information delivery by using the information delivery apparatus according to the specific information of the input apparatus and information on a user.
